(19) United States
(12) Patent Application Publication
(10) Pub. No.: US 2004/0257482 A1
(43) Pub. Date: Dec. 23, 2004

(54) Picture display device of the index type

(76) Inventors: Oscar Hendrikus Willemsen, Eindhoven (NL); Hendrikus Bernardus Van Den Brink, Eindhoven (NL)

Correspondence Address: US Philips Corporation, Intellectual Property Department, P O Box 3001, Briarcliff Manor, NY, 10510, US

(21) Appl. No.: 10/493,769

(22) PCT Filed: Oct. 25, 2002
(86) PCT No.: PCT/IB02/04501

(30) Foreign Application Priority Data
Oct. 29, 2001 (EP) 01204129.9
Jun. 21, 2002 (EP) 02077462.6

(51) Int. Cl. H01J 29/10

(52) U.S. Cl. 348/811; 313/471

(57) ABSTRACT

Picture display device (1) comprising a cathode ray tube (2) whose display screen (4) is provided with parallel image lines (10) along which an electron beam (5) is scanned, and with pairs of first and second phosphorescent index elements extending along opposed sides of each image line (10). The device also comprises a pair of photodetectors (31,32) for generating index signals indicative of the amount of irradiation by the electron beam (5) of said index elements. An error signal is constructed based on a difference of said index signals for correcting the shape and/or the position of the electron beam (5) on the screen. The index signal of one of the photodetectors is indicative of the amount of irradiation of both the first and the second index elements (11, 12), which improves the detection efficiency of said detector and the signal/noise ratio of its index signal. This results in a better error signal and thus in a better image quality.

### FIELD OF THE INVENTION

The invention relates to a picture display device comprising a cathode ray tube having a display screen comprising at least one image line along which an electron beam is scanned when in operation, a first index element arranged along one side of the at least one image line and having a first colour and a second index element arranged along an opposite side of the at least one image line and having a second colour different from the first colour, a first and a second photodetector for detecting light emitted by the index elements upon irradiation of the index elements by the electron beam.

### DESCRIPTION OF PRIOR ART

Picture display devices comprising such phosphorescent index elements and associated photodetectors are known from patent number U.S. Pat. No. 4,635,106.

The photodetectors of the known display devices deliver index signals when the electron beam impinges on the index elements.

These index signals are indicative of the position of the electron beam with respect to said index elements and/or of the shape of the electron beam.

An error signal is generated based on these index signals, and is subsequently used in a control loop in order-to correct the trajectory and/or shape of the electron beam when it deviates from its nominal trajectory and/or shape.

Although the known devices work well in many circumstances, there is a wish to control the electron beam position and/or shape more accurately.

### SUMMARY OF THE INVENTION

It is an object of the invention to provide an index display device with an improved error signal.

To this end, the display device in accordance with the invention is characterized in that

the first photodetector generates when in operation a first index signal S1 substantially indicative of an amount of irradiation R1 by the electron beam of the first index element,

and in that

the second photodetector generates when in operation a second index signal S2 substantially indicative of a sum of the amount of irradiation R1 and an amount of irradiation R2 by the electron beam of the second index element,

and in that

the device further comprises means for generating an error signal indicative of a difference between said first and second index signals, and means for correcting the shape of the electron beam and/or the position of the electron beam in a frame direction perpendicular to the at least one image line, in function of said error signal.

With the known index display devices, the first photodetector generates a first index signal substantially indicative of an amount of irradiation by the electron beam of the first index element, and the second photodetector generates a second index signal substantially indicative of an amount of irradiation by the electron beam of the second index element. Such distinctive sensing of both amounts of irradiation is achieved by having index elements of distinct colours, i.e. index elements which—when irradiated by the electron beam—emit light with distinctively different frequency spectra, and by having photodetectors selectively sensitive to each distinct spectrum. The error signal used for correcting the trajectory and/or the shape of the electron beam is based on a difference between both index signals.

With an index display device according to the invention, the second photodetector has a colour detection range which includes both the first and the second colour. The second photodetector generates therefore an index signal which is substantially indicative of an amount of irradiation by the electron beam of both the first and the second index elements.

This increases the level of the second index signal and therefore the signal/noise ratio of the second index signal. Since the error signal is based on a difference between the first and the second index signals, the signal/noise ratio of the error signal is also improved. This results in a more accurate correction of the electron beam trajectory in the frame direction and/or of the shape of the electron beam, which in turn results in an improvement of the image quality. This effect is particularly useful at low electron beam intensities, i.e. for darker portions of the image to be displayed.

There are several ways to achieve this.

In a preferred embodiment, the first photodetector comprises a first photosensitive element having a colour detection range which includes both the first and the second colour, said first photosensitive element being provided with an optical filter for selectively filtering the first colour, and having the second photodetector comprising a second photosensitive element whose colour detection range also includes both the first and the second colour, said second photosensitive element not being provided with an optical filter for selectively filtering the first or the second colour. It is to be noted that the elimination of one filter moreover reduces the cost of the second photodetector.

In another preferred embodiment, the first photodetector comprises a first photosensitive element having a colour detection range which includes the first colour while substantially excluding the second colour, and the second photodetector comprises a second photosensitive element having a colour detection range which includes both the first and the second colour, neither of the photosensitive elements being provided with an optical filter for selectively filtering the first or the second colour.

In case an optical filter is used, it is advantageous to make use of a low-pass filter since low-pass filters are more selective and cheaper. Accordingly in preferred embodiments, a dominant frequency of the first colour is smaller than a dominant frequency of the second colour.

Preferably, the first colour is green, the second colour is blue and the optical filter is a yellow filter.

In case an optical filter is used, it is furthermore advantageous to use identical first and second photosensitive elements in order to simplify control circuitry.

Accordingly, in preferred embodiments, the first photosensitive element of the first photodetector is substantially the same as the second photosensitive element of the second photodetector.

These and other aspects of the invention are apparent from and will be elucidated with reference to the embodiments described hereafter.

### SHORT DESCRIPTION OF THE DRAWINGS

In the Drawings:

FIG. 1 shows schematically a known index display device;

FIG. 2 shows schematically the display screen of the index display device of FIG. 1;

FIGS. 3a and 3b are exemplary graphs showing how the index signals depend on the amount of irradiation of the index elements by the electron beam for a known display device;

FIGS. 4a and 4b are exemplary graphs showing how the index signals depend on the amount of irradiation of the index elements by the electron beam for a display device according to the invention;

FIG. 5 shows schematically the photodetectors of a display device according to a preferred embodiment of the invention;

FIG. 6 is a graph showing exemplary spectral characteristics of the photodetectors of FIG. 5;

FIG. 7 shows schematically the photodetectors of a display device according to another preferred embodiment of the invention;

FIG. 8 is a graph showing exemplary spectral characteristics of the photodetectors of FIG. 7;

FIG. 9 shows schematically an exemplary means for generating the error signal,

FIG. 10 shows an embodiment according to the invention,

FIG. 11 shows a further embodiment according to the invention; and

FIG. 12 hows a preferred embodiment according to the invention.

The figures are not drawn to scale. Generally, identical components are denoted by the same reference numerals in the figures.

### DETAILED DESCRIPTION OF PREFERRED EMBODIMENTS

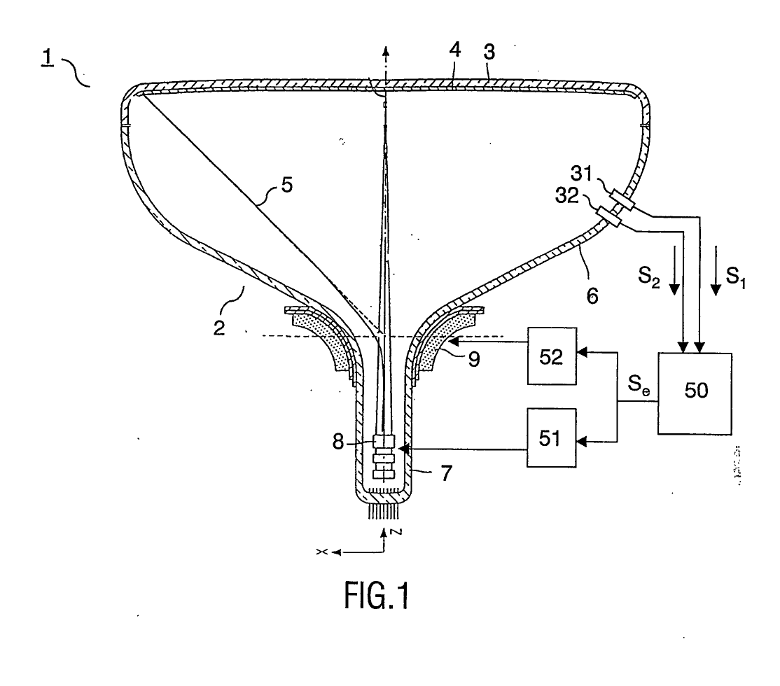

FIG. 1 shows a picture display device 1 of the index type comprising a cathode ray tube 2 having a display window 3, a cone 6 and a neck 7. The neck 7 accommodates a means 8 for generating at least one electron beam 5. A deflection means 9 is mounted on the cone 6 for deflecting the electron beam 5 across the display window 3. A display screen 4 is situated on the inner side of the display window 3. Said display screen 4 comprises a plurality of phosphorescent image lines 10 disposed side by side and along which the electron beam 5 is scanned for forming a picture on the display screen 4.

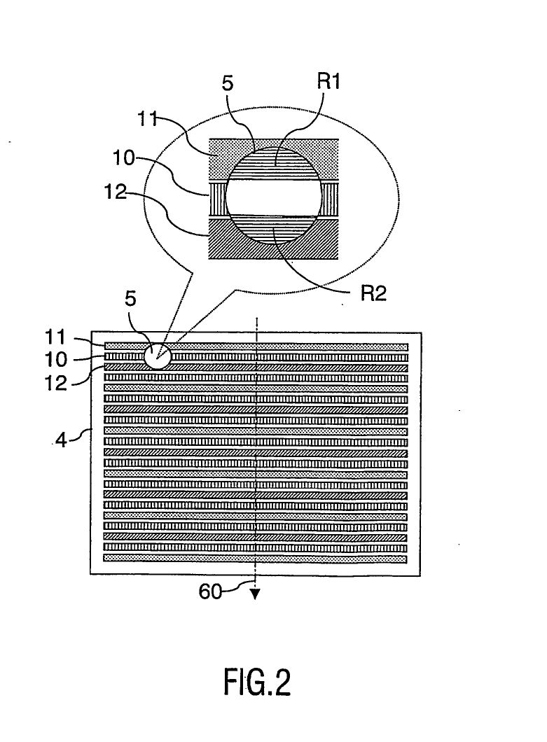

Phosphorescent index elements extend on each side of the image lines 10, as can be seen on FIG. 2. A first index element 11 extends along one side of the image line 10 and a second index element 12 extends along an opposite side of the image line 10.

When the electron beam 5 scans over the image line 10, it partially irradiates the first 11 and the second 12 index elements, as can be better seen in the enlarged portion of FIG. 2. The amount of irradiation by the electron beam 5 of the first 11 and second 12 index elements are respectively indicated by R1 and R2. It can be easily understood that R1 and R2 depend on the shape of the electron beam 5 and on the position of the electron beam 5 in a frame direction 60 perpendicular to the image line 10. This irradiation causes the first and second index elements to produce light which is detected by two photodetectors—a first photodetector 31 and a second photodetector 32—usually located against or at least partially in the cathode ray tube 2. Upon detection of said light, the photodetectors generate index signals S₁ and S₂ which are consequently indicative of the position of the electron beam 5 with respect to the first and second index elements and/or of the shape of the electron beam 5.

A means for generating an error signal is connected to the photodetectors for measuring these index signals S₁ and S₂ and for delivering an error signal Sₑ which is in this example used by a control loop comprising a first control means 51 acting on the deflection means 9 in order to correct the trajectory of the electron beam 5 when it deviates from its nominal trajectory and/or comprising a second control means 52 acting on the means 8 for generating the electron beam 5 in order to correct the shape of the electron beam 5 when it deviates from its nominal shape.

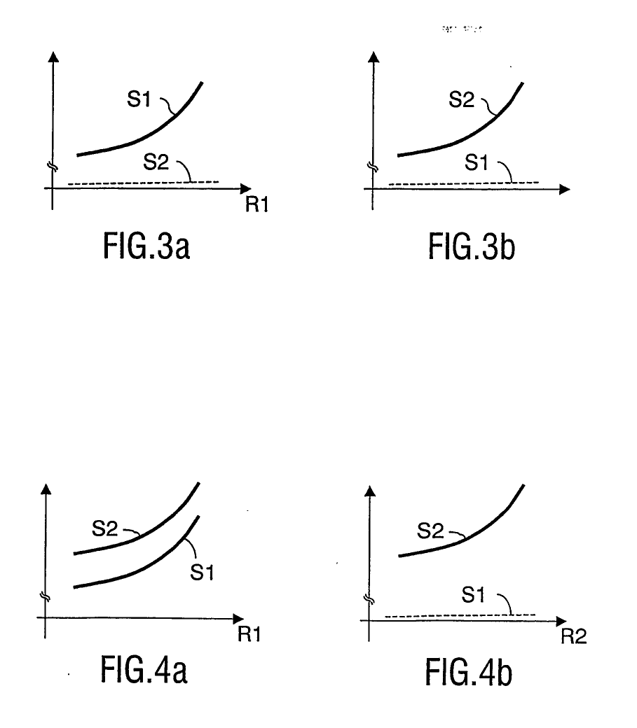

FIGS. 3a and 3b are exemplary graphs showing schematically how the index signals S1 and S2 depend on R1 and R2 for a known index display device.

FIG. 3a shows that S1 varies with R1, whereas S2 does not vary with R1 (except for minor variations due to noise, interference, etc . . . ). This is due to the first photodetector 31 being substantially sensible to the light emitted by the first index line, and the second photodetector 32 not being substantially sensible to the light emitted by the first index line.

FIG. 3b shows that S2 varies with R2, whereas S1 does not vary with R2 (except for minor variations due to noise, interference, etc . . . ). This is due to the second photodetector 32 being substantially sensible to the light emitted by the second index line, and the first photodetector 31 not being substantially sensible to the light emitted by the second index line.

Accordingly the first index signal S1 will be substantially proportional to R1, whereas the second index signal S2 will be substantially proportional to R2.

The present invention offers an improved display device, as will be understood from FIG. 4a and FIG. 4b.

FIGS. 4a and 4b are exemplary graphs showing how the index signals S1 and S2 depend on R1 and R2 for a display device according to the invention.

FIG. 4a shows that S1 and S2 both vary with R1. This is due to the first photodetector 31 and the second photodetector 32 being both substantially sensible to the light emitted by the first index line.

FIG. 4b shows that S2 varies with R2, whereas S1 does not vary with R2 (except for minor variations due to noise, interference's; etc . . . ). This is due to the second photodetector 32 being substantially sensible to the light emitted by the second index line, and the first photodetector 31 not being substantially sensible to the light emitted by the second index line.

Accordingly the first index signal S1 will be substantially proportional to R1, whereas the second index signal S2 will be substantially proportional to the sum of R1 and R2.

This increases the level of the second index signal and therefore the signal/noise ratio of the second index signal. Since the error signal Se is based on a difference between the first and the second index signals, the signal/noise ratio of the error signal is also improved. This results in a more accurate correction of the position of the electron beam 5 in the frame direction 60 and/or of the shape of the electron beam 5, which in turn results in an improvement of the image quality. Such effect is particularly useful at low electron beam intensities, i.e. for darker portions of the image to be displayed.

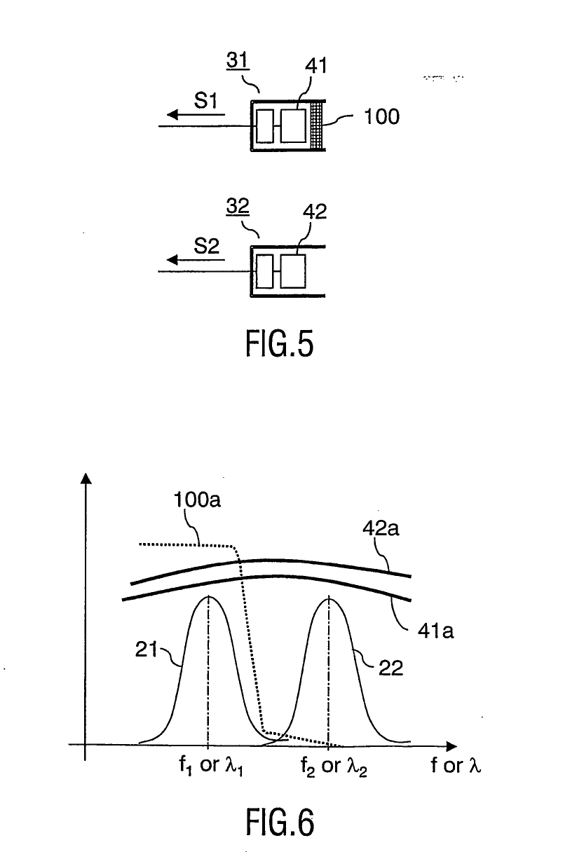

In a preferred embodiment of the display device according to the invention, the first and the second photodetectors 31, 32 are constructed as shown schematically on FIG. 5 and have spectral characteristics as shown on the graph of FIG. 6.

FIG. 6 also shows spectral emission characteristics of the index elements when irradiated by the electron beam 5. A first spectral emission characteristic 21 of the first index element 11 corresponds to the first colour and can be clearly distinguished from a second spectral emission characteristic 22 of the second index element 12 corresponding to the second colour.

In such a preferred embodiment, the first photodetector 31 comprises a first photosensitive element 41 having a colour detection range which includes both the first and the second colour as can be seen from a first spectral sensitivity characteristic 41 a of the first photosensitive element 41. The second photodetector 32 comprises a second photosensitive element 42 having a colour detection range which also includes both the first and the second colour as can be seen from a second spectral sensitivity characteristic 42a of the second photosensitive element 42. Such a photosensitive element may for example comprise a photosensitive semiconductor such as a photodiode or a phototransistor. It is to be noted that a photosensitive element may comprise one or several photodiodes and/or phototransistors either grouped together or distributed on the cone 6 of the cathode ray tube 2 for improving the light detection efficiency.

The first photosensitive element 41 is provided with an optical filter 100 for selectively filtering the first colour, as can be seen from a spectral transmission characteristic 100a of the optical filter 100. The second photosensitive element 42 is not provided with an optical filter 100 for selectively filtering the first or the second colour.

When the electron beam 5 impinges on the index elements, the first index signal S1 will accordingly be substantially indicative of the amount of light of the first colour and thus of R1, whereas the second index signal will be substantially indicative of the amount of light of both the first colour and the second colour and thus of R1+R2.

It is to be noted that the horizontal (abscissa) axis of the graph of FIG. 6 can be read in terms of frequencies (f) or of wavelengths (λ), so that the optical filter 100 may be a low-pass filter, a high-pass filter, or a band-pass filter.

Preferably, the first colour has a first dominant frequency f1 which is smaller than a second dominant frequency f2 of the second colour, in which case the horizontal (abscissa) axis of the graph of FIG. 6 is to be read in terms of frequencies (f). In this case, the optical filter 100 for filtering the first colour is a low-pass filter. This is advantageous since low-pass filters are more selective and cheaper.

In a most preferred case, the first colour is dominantly green, the second colour is dominantly blue and the optical filter 100 is a dominantly yellow filter, since these colours are well separated in the frequency domain and since yellow filters are very cheap and very selective.

It is furthermore advantageous to use identical first and second photosensitive elements 41, 42 in order to simplify control circuitry. Two identical photodiodes for example will have substantially the same characteristics and can also be easily integrated on a same substrate.

Accordingly, in preferred embodiments, the first photosensitive element 41 of the first photodetector 31 is substantially the same as the second photosensitive element 42 of the second photodetector 32.

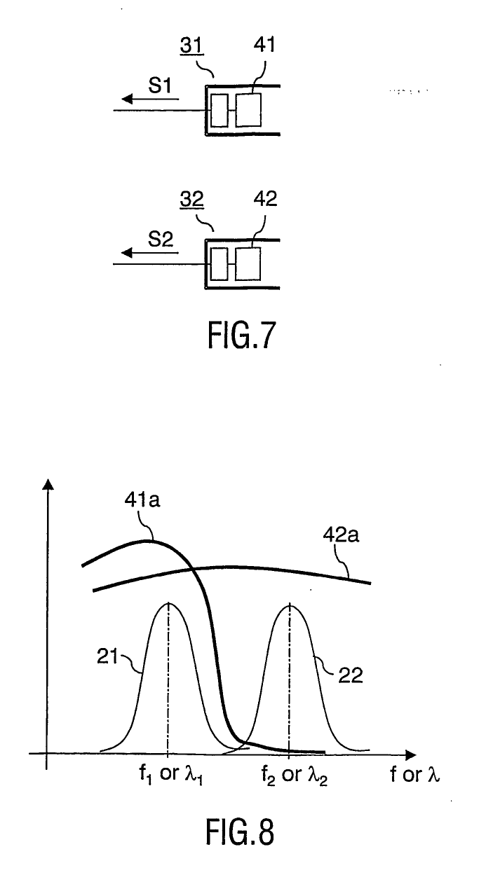

In another preferred embodiment of the display device according to the invention, the first and the second photodetectors 31, 32 are constructed as shown schematically on FIG. 7 and have spectral characteristics as shown on FIG. 8.

FIG. 8 also shows spectral emission characteristics of the index elements when irradiated by the electron beam 5. A first spectral emission characteristic 21 of the first index element 11 corresponds to the first colour and can be clearly distinguished from a second spectral emission characteristic 22 of the second index element 12 corresponding to the second colour.

In such another preferred embodiment, the first photodetector 31 comprises a first photosensitive element 41 having a colour detection range which includes the first colour and which excludes the second colour as can be seen from a first spectral sensitivity characteristic 41a of the first photosensitive element 41. The second photodetector 32 comprises a second photosensitive element 42 having a colour detection range which includes both the first and the second colour as can be seen from a second spectral sensitivity characteristic 42a of the second photosensitive element 42. It is to be noted that the horizontal (abscissa) axis of the graph of FIG. 8 can be read in terms of frequency (f) or of wavelength (λ). Neither the first photosensitive element 41 nor the second photosensitive element 42 is provided with an optical filter 100 for selectively filtering the first or the second colour.

When the electron beam 5 impinges on the index elements, the first index signal S1 will accordingly be substantially indicative of the amount of light of the first colour and thus of R1, whereas the second index signal will be substantially indicative of the amount of light of both the first colour and the second colour and thus of R1+R2.

Whether an optical filter 100 is used or not, the levels of the index signals S1 and S2 can thus considerably differ from each other, even if the amounts of irradiation R1 and R2 are equal, i.e. when the electron beam 5 is correctly positioned in the frame direction 60 with regard to the image line 10. In order to compensate for such difference as well as for unbalances in optical paths and electrical circuits, the means for generating the error signal operates a weighted difference of the second index signal and the first index signal in order that the error signal Sₑ equals zero when the electron beam 5 is correctly positioned:

Sₑ=f(k₂·S₂−k₁·S₁),

k₁ and k₂ being constants which have to be adjusted for differences in light production efficiency of the index elements and in light detection efficiency of the photodetectors, so that Sₑ=0 when R1=R2

Since the index signals of the first and the second photodetectors 31, 32 for a given electron beam intensity and for a given electron beam position with regard to the first and second index elements 11, 12 strongly depend on the angular positions of the electron beam 5 in the frame direction 60 as well as in a direction of the image line (usually called the deflection angles), it may be advantageous that the error signal be relative to an amount which is indicative of the total irradiation by the electron beam 5 of the first and the second index elements 11, 12. As said before, the second index signal S2 is indicative of such an amount.

Accordingly, in a preferred embodiment of present invention, the error signal Sₑ is constructed as follows:

Sₑ=f((k₂·S₂−k₁·S₁)/(k₃·S₂+k₄·S₁)),

k₁, k₂, k₃ and k₄ being constants which have to be adjusted for differences in light production efficiency of the index elements and in light detection efficiency of the photodetectors, and for imperfections in optical filtering characteristics (in case a filter is used), so that Sₑ=0 when R1=R2

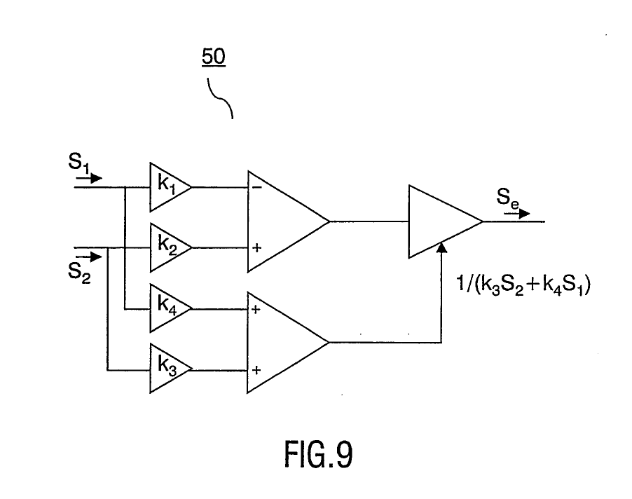

An exemplary means for generating such an error signal is shown in FIG. 9.

In conventional index tubes the two detectors can never be positioned at exactly the same position, and therefore the distribution of the detection efficiencies will never coincide exactly. The result of such a configuration is a difference in gain for the detectors.

The solution to the problem is to position the two detectors as close as possible together. Then the distributions of the detector efficiencies are almost the same so that the same normalisation for both detectors is sufficient. The normalisation can then be done by dividing the difference of the signals from the two detectors by the sum of the two signals.

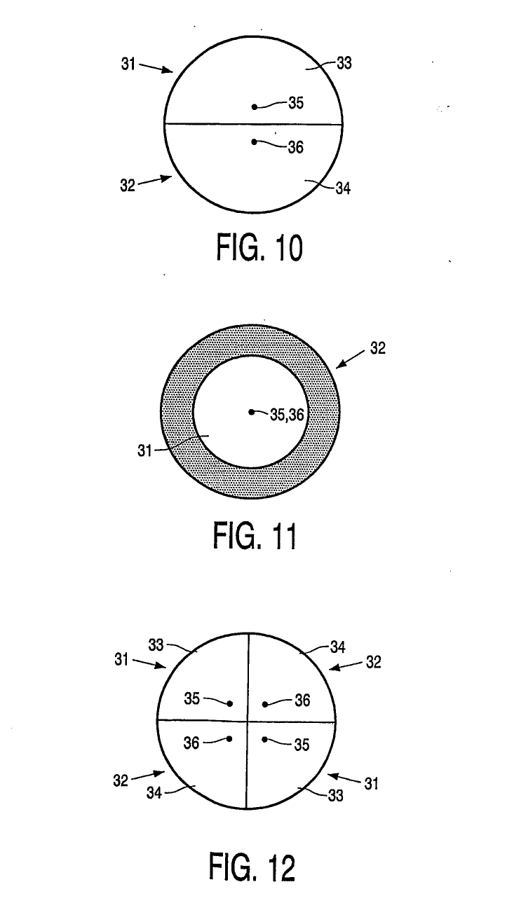

An embodiment of such photodetectors is shown in FIG. 10, showing the first photodetector 31 and the second photodetector 32 each having a surface area 33, 34. Each surface area 33, 34 has a center of gravity 35 and 36, the distance between the centers of gravity being less then 2 cm. In this case the first and the second surface area are semicircular-shaped. The advantages of this configuration are that it is easy to make and that electrical connections to the detectors are easy provided.

From measurements in a 17″ tube it was demonstrated that if the detectors are positioned at a distance of 2 cm away from each other disturbing effects already occur. The distance between the detectors should therefore be at least smaller than 2 cm.

A further embodiment of the invention comprises integrated detectors, i.e. the detectors have centers of gravity 35 and 36 that substantially coincide. By integrating the detectors with equal surface areas into one integrated detector, the two detectors are effectively positioned on the same location within the tube and have a similar response characteristic. Since the solid angle that is observed by the two detectors is equal, the detection efficiency of the photo-detectors is equal.

The best way of integrating the detectors is to make an integrated device on silicon, so that both detectors can be combined on one chip. By use of silicon technology it is also possible to incorporate a filter on top of a detector, as well as to amplify the current coming from the detectors. Two advantageous embodiments are shown in FIGS. 1 and 12.

FIG. 11 shows an embodiment of the invention in which the first detector 31 has a first surface area 33 which is circular-shaped and the second detector 32 has a second surface area 34 which is ring-shaped, the second surface being positioned around the first detector. The corresponding centers of gravity 35 and 36 coincide.

FIG. 12 shows an embodiment of the invention in which the first and second detectors 31, 32 have first and second surface areas 33, 34 that comprise circular segments (4 segments in this example), and wherein each segment of the first detector is positioned between two segments of the second detector.

It is also fairly easy to make more complicated detector configurations. All these structures should be constructed such that the points of gravity of the two detectors are as close as possible, and ideally, they should coincide.

In short the invention may be described as follows. Picture display device 1 comprising a cathode ray tube 2 whose display screen 4 is provided with parallel image lines 10 along which an electron beam 5 is scanned, and with pairs of first and second phosphorescent index elements extending along opposed sides of each image line 10. The device also comprises a pair of photodetectors for generating index signals indicative of the amount of irradiation by the electron beam 5 of said index elements. An error signal is constructed based on said index signals for correcting the shape and/or the position of the electron beam 5 on the screen. The index signal of one of the photodetectors is indicative of the amount of irradiation of both the first and the second index elements 11, 12, which improves the detection efficiency of said detector and the signal/noise ratio of its index signal. This results in a better error signal and thus in a better image quality.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of other elements or steps than those listed in a claim. The word “a” or “an” preceding an element does not exclude the presence of a plurality of such elements.

Terminology

1 Picture display device (1)

2 Cathode ray tube (2)

3 Display window (3)

4 Display screen (4)

5 Electron beam (5)

6 Cone (6)

7 Neck (7)

8 Means (8) for generating an electron beam (5)

9 Deflection means (9)

10 Image line (10)

11 First index element (11)

12 Second index element (12)

21 First spectral emission characteristic

22 Second spectral emission characteristic

31 First photodetector (31)

32 Second photodetector (32)

33 Surface area of first detector

34 Surface area of second detector

35 Center of gravity of first surface area

36 Center of gravity of second surface area

41 First photosensitive element (41)

41a First spectral sensitivity characteristic

42 Second photosensitive element (42)

42a Second spectral sensitivity characteristic

50 Means for generating an error signal

51 First control means (51) (for correcting the position of the el. beam)

52 Second control means (52) (for correcting the shape of the el. beam)

60 Frame direction (60)

100 Optical filter (100)

100a Spectral transmission characteristic

1. A picture display device comprising
a cathode ray tube having a display screen comprising at least one image line along which an electron beam is scanned when in operation, a first index element arranged along one side of the at least one image line and having a first colour and a second index element arranged along an opposite side of the at least one image line and having a second colour different from the first colour,
a first and a second photodetector for detecting light emitted by the index elements upon irradiation of the index elements by the electron beam,
characterized in that the first photodetector generates when in operation a first index signal S1 substantially indicative of an amount of irradiation R1 by the electron beam of the first index element, and in that
the second photodetector generates when in operation a second index signal S2 substantially indicative of a sum of the amount of irradiation R1 and an amount of irradiation R2 by the electron beam of the second index element, and in that
the device further comprises means for generating an error signal indicative of a difference between said second and first index signals, and means for correcting the shape of the electron beam and/or the position of the electron beam in a frame direction perpendicular to the at least one image line, in function of said error signal.

2. A picture display device according to claim 1, characterized in that the first photodetector comprises a first photosensitive element sensitive to both the first colour and to the second colour, said first photosensitive element being provided with an optical filter selectively filtering the first colour, and in that the second photodetector comprises a second photosensitive element sensitive to both the first colour and to the second colour, said second photosensitive element not being provided with an optical filter for filtering the first or the second colour.

3. A picture display device according to claim 2, characterized in that a dominant frequency of the first colour is smaller than a dominant frequency of the second colour, and in that the optical filter has a transmission characteristic for substantially filtering a frequency spectrum of the first colour.

4. A picture display device according to claim 3, characterized in that the first colour is dominantly green and in that the second colour is dominantly blue, and in that the filter is a dominantly yellow filter.

5. A picture display device according to claim 4, characterized in that the first photosensitive element is substantially the same as the second photosensitive element.

6. A picture display device according to claim 1, characterized in that the first photodetector comprises a first photosensitive element sensitive to the first colour and not to the second colour, and in that the second photodetector comprises a second photosensitive element sensitive to both the first colour and the second colour.

7. A picture display device according to claim 5, characterized in that the error signal Sₑ is indicative of a weighted difference between the second index signal S₂ and the first index signal S₁:
Sₑ=f(k₂·S₂−k₁·S₁).

8. A picture display device according to claim 7, characterized in that the error signal Se is indicative of a weighted difference between the second index signal S₂ and the first index signal S₁, relative to a weighted sum of the second index signal S₂ and the first index signal S₁:
Sₑ=f((k₂·S₂−k₁·S₁)/(k₃·S₂+k₄·S₁)).

9. A picture display device according to claim 1, wherein the first photodetector and the second photodetector have surface areas, each surface area having a center of gravity, a distance between the centers of gravity being less then 2 cm.

10. A picture display device according to claim 9, wherein the centers of gravity substantially coincide.

11. A picture display device according to claim 9, wherein the first and the second surface area are semicircular-shaped.

12. A picture display device according to claim 9, wherein the first surface area is circular-shaped and the second surface area is ring-shaped, the second surface area being positioned around the first surface area.

13. A picture display device according to claim 9, wherein the first and the second surface area comprise circular segments, each circular segment of the first detector being positioned between circular two segments of the second detector.
